(19) United States
(12) Patent Application Publication
(10) Pub. No.: US 2022/0278377 A1
(43) Pub. Date: Sep. 1, 2022

(54) A PORTABLE DEVICE AND AN APPARATUS FOR REPLACING USED BATTERY OF THE PORTABLE DEVICE

(71) Applicants: Moshe AMZALEG, Meitar (IL); Ilan BEN HARUSH, Tel Aviv (IL)

(72) Inventors: Moshe AMZALEG, Meitar (IL); Ilan BEN HARUSH, Tel Aviv (IL)

(21) Appl. No.: 17/632,104

(22) PCT Filed: Aug. 7, 2019
(86) PCT No.: PCT/IL2019/050897

§ 371 Date: Feb. 1, 2022

(51) Int. Cl. H01M 10/42; H02J 7/00; G07F 17/00; H01M 10/44; H01M 10/46; H01M 50/264; H01M 10/48

(52) U.S. Cl. CPC H01M 10/425; H02J 7/005; H02J 7/0013; H02J 7/007; G07F 17/0042; H01M 10/441; H01M 10/46; H01M 50/264; H01M 10/482; H01M 2010/4271; H01M 2010/4278

(57) ABSTRACT

An apparatus for replacing a used battery pack of a portable device with a charged battery pack. The apparatus is configured to receive a portable device with the battery pack housed therein, unlock the battery pack by automation means and extract it from the housing, insert and lock another battery pack into the housing. In another aspect, the invention relates to a portable device comprising a battery pack and battery pack housing, which is configured to be inserted into the housing, locked therein and provide electrical charge either to the housing or to devices that are electrically connected to the housing. The battery pack may be unlocked and retrieved from the housing and, in turn, replaced with another battery pack (e.g. a charged battery pack).

### FIELD OF THE INVENTION

The present invention relates to the field of batteries for mobile devices. More particularly, the invention relates to an apparatus for replacing used battery of a portable device and for a portable device that includes at least one replaceable battery or a replaceable battery pack.

### BACKGROUND OF THE INVENTION

Power banks are used for supplying electrical power to electric devices (e.g. in particular mobile devices such as smartphones, tablets, PDAs, etc.), typically via a Universal Serial Bus (USB) port. Power banks provide a solution to the ever-growing demand for high performance alongside the limitation in battery capacity (and therefore battery charge) of electrical devices.

A typical user encounters a low battery once in a while and is not always able to connect the device to an electricity outlet to recharge the battery. In such a situation, the user may connect the electrical device to a power bank and continue to use the device on-fly, i.e. without the need of connecting the device to a power outlet. Several power banks exist which comprise a logo or brand name on their external casing, while other power banks allow user personalization, i.e. determine its appearances. Users often wish to keep the appearance of their power bank for various reasons (e.g. sentimental, social or other reasons).

Power banks, as well as the electrical devices, have limited battery charge. Consequently a user might connect an electrical device to a power bank, and remain once again with low battery charge (or none at all). One solution to this is to carry around a plurality of power banks. However this solution is very inconvenient. Another solution is to recharge the electrical device and/or the power bank from a power outlet. However this solution is highly time-consuming as it takes a long time for a battery to recharge.

Several existing systems solve the problem of a low charged power bank, by allowing a user to exchange a power bank with a charged power bank. In these systems a user may insert a power bank to a vending machine (or another machine of the sort) and receive in return another power bank. This solution is inappropriate in case the user wishes to keep his personal power bank.

In one aspect, it would be profitable to have a system for quickly and conveniently providing a charged power bank, while allowing keeping of a user's personal power bank. In another aspect, it would be profitable to have a system for quickly and conveniently replacing used battery for a portable device, whether the portable device is a power bank or alternatively it is a mobile device such as a smartphone, digital cameras, navigation devices, wearable electric devices, etc.

It is therefore an object of the present invention to provide a system with which a user may obtain a charged portable device, whether the portable device is a power bank or a mobile device such as a smartphone.

It is another object of the present invention to provide a system with which a user's personal power bank or mobile device may quickly obtain charge.

Other objects and advantages of the invention will become apparent as the description proceeds.

### SUMMARY OF THE INVENTION

The present invention relates to a portable device, comprising:

a) a battery pack adapted to provide electrical power;

b) a housing suitable to house the battery pack and enable use of the electric charge of the housed battery pack, characterized in that the battery pack that is housed in the housing is reversibly locked therein; and

c) locking arrangement adapted to reversibly lock the battery pack within the housing by using automation means.

According to an embodiment of the invention, the battery pack comprises a locking arrangement with which it may be reversibly locked inside the housing. For example, a housed battery pack is reversibly magnetically locked inside the housing.

According to an embodiment of the invention, the housing comprises a locking arrangement with which the battery pack may be reversibly locked inside the housing by using the automation means.

According to an embodiment of the invention, the battery pack and the housing comprise corresponding locking arrangements with which the battery pack may be reversibly locked inside the housing by using the automation means.

According to an embodiment of the invention, the battery pack comprises a processing unit configured to detect charge activity of the battery pack.

In another aspect, the present invention relates to an apparatus for replacing used battery pack of the portable device with a charged battery pack without replacing the housing by using the automation means.

According to an embodiment of the invention, the apparatus comprising:

a) a plurality of charged battery packs, either charged or suitable to be recharged, wherein each battery pack comprises a locking arrangement adapted to reversibly lock the battery pack within a housing of the portable device;

b) an aperture through which portable device may be inserted to the apparatus (e.g., similar to an insertion port of a vending kiosk machine for renting digital video discs);

c) an unlocking apparatus for unlocking battery packs from inserted portable devices;

d) a grabbing element for retrieving unlocked battery packs from portable devices; and

e) an insertion element for inserting charged battery packs into housings.

According to an embodiment of the invention, the apparatus further comprises a processing unit.

According to an embodiment of the invention, the apparatus further comprises a communication module.

According to an embodiment of the invention, the apparatus further comprises a battery pack recycling receptacle.

According to an embodiment of the invention, the apparatus further comprises a battery checking unit configured to check the health and overall condition of the used battery pack, thereby enabling to determine whether the health and overall condition of the battery is suitable for additional charging cycle.

According to an embodiment of the invention, the processing unit is used for managing the recharging of the battery packs and to allow one or more of said battery packs to be optimally recharged.

In yet another aspect, the present invention relates to a system for replacing used battery packs of portable devices, comprising: a plurality of portable devices and one or more apparatuses for replacing used battery pack of the portable device with a charged battery pack without replacing the housing of the portable device.

According to an embodiment of the invention, the battery packs of the plurality of portable devices comprise an identification mark.

According to an embodiment of the invention, the housings of the plurality of portable devices comprise identification means.

According to an embodiment of the invention, the system further comprises a software application for mobile electrical devices configured to track and manage usage of battery packs.

In a further aspect, the present invention relates to a method of providing charge to the portable device, comprising:

a) unlocking the battery pack from the housing of the portable device;

b) gripping and retrieving the battery pack from the housing of the portable device; and

c) inserting a charged battery pack into the housing.

According to an embodiment of the invention, the method performed by the apparatus for replacing used battery pack of the portable device with a charged battery pack, wherein the portable device is inserted to the apparatus before the used battery pack is unlocked and is ejected from the apparatus after the charged battery pack is inserted into the housing.

The present invention further relates to an apparatus for battery operated rechargeable mobile devices configured to receive a battery operated rechargeable mobile device and replace the battery pack of the mobile device with a charged battery pack.

In another aspect, the present invention relates to a method of providing charge to a battery operated rechargeable mobile device with a removable battery pack, comprising:

a) inserting the mobile device into a dedicated apparatus that is adapted for replacing a used battery pack of the mobile device;

b) unlocking the used battery pack;

c) gripping and extracting the used battery pack from the housing;

d) inserting a charged battery pack into the housing; and

e) ejecting the mobile device from the apparatus.

### BRIEF DESCRIPTION OF THE DRAWINGS

In the drawings:

FIG. 1A schematically illustrates a personal portable power bank that includes a power bank and a housing, according to an embodiment of the present invention;

FIG. 1B schematically illustrates the power bank of FIG. 1A with the battery pack partially inserted into the housing, according to an embodiment of the present invention;

FIG. 1C schematically illustrates a side cutaway view of a magnetic locking mechanism suitable to lock the battery pack in the housing, according to an embodiment of the invention;

FIG. 1D schematically illustrates a side cutaway view of the magnetic locking mechanism of FIG. 1C in an unlock state, according to an embodiment of the invention

FIG. 2A schematically illustrates a perspective view of an apparatus for replacing used battery of a portable device, according to an embodiment of the present invention;

FIG. 2B schematically illustrates the steps of replacing a used battery with a charged one, according to an embodiment of the invention; and

FIG. 3 shows a flowchart describing the process of obtaining a charged battery pack from an apparatus for replacing used battery of a portable device, according to an embodiment of the present invention.

### DETAILED DESCRIPTION OF THE INVENTION

Reference will now be made to an embodiment of the present invention, examples of which are provided in the accompanying figures for purposes of illustration only. One skilled in the art will readily recognize from the following description that alternative embodiments of the structures and methods exemplified herein may be employed, mutatis mutandis, without departing from the principles of the invention.

The present invention relates to a portable device comprising a battery pack and a battery pack housing. The battery pack is configured to be inserted into the housing, locked therein and provide electrical charge either to the housing or to devices that are electrically connected to the housing. The battery pack may be unlocked and retrieved from the housing and, in turn, replaced with another battery pack (e.g. a charged battery pack). According to an embodiment of the invention, the portable device is a power bank or other form of a mobile charger that can be charged in advance for later mobile device (e.g., phones, tablets, wearable devices or laptops) to recharge (without a power socket). According to another embodiment of the present invention, the portable device is a mobile device such as a smartphone, tablet, smart wearable device, etc. In such embodiment, the battery pack housing refers to the body of the mobile device to which the battery pack is configured to be inserted, locked therein and provides electrical charge to power the mobile device.

Furthermore, the present invention relates to an apparatus for replacing a used battery pack of the portable device with a charged battery pack. According to an embodiment of the invention, the apparatus is configured to receive a portable device with the battery pack housed therein, unlock the battery pack by automation means and extract it from the housing, insert and lock another battery pack into the housing.

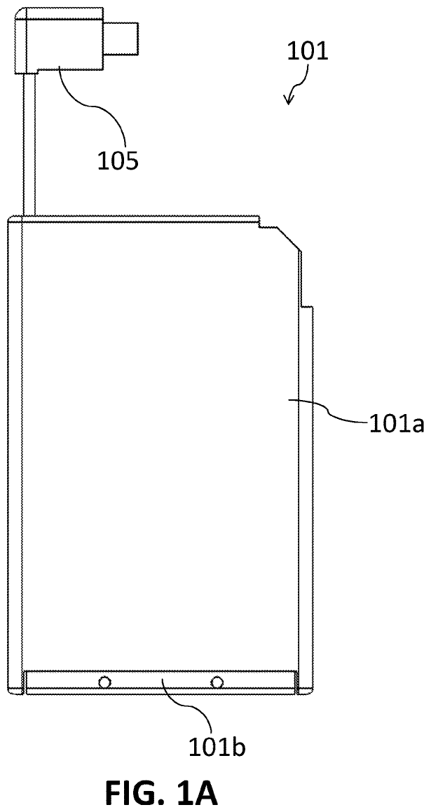

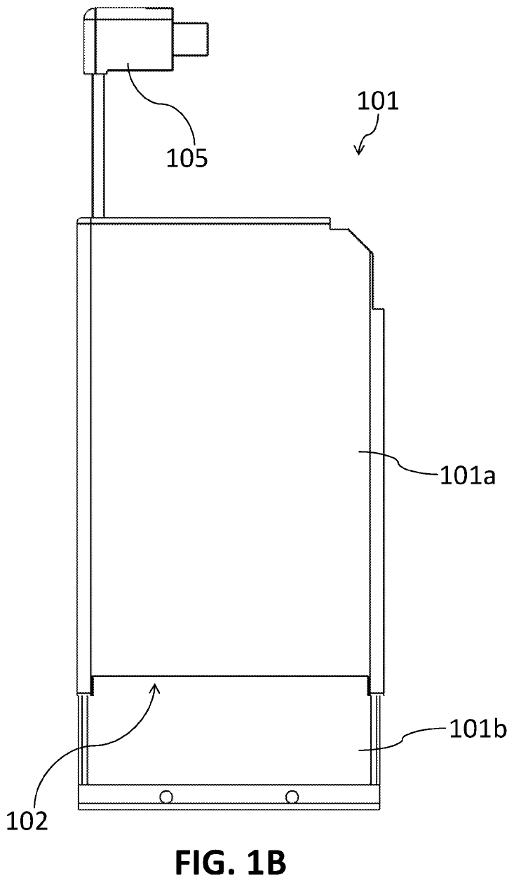

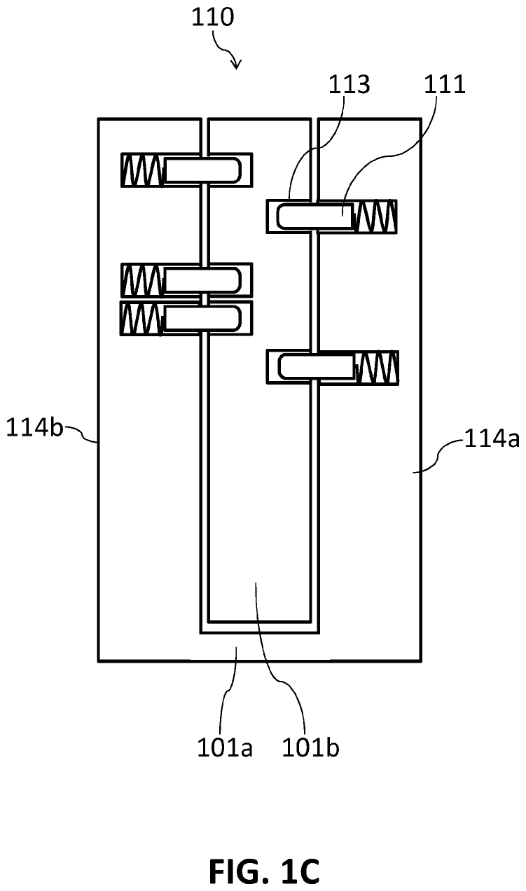

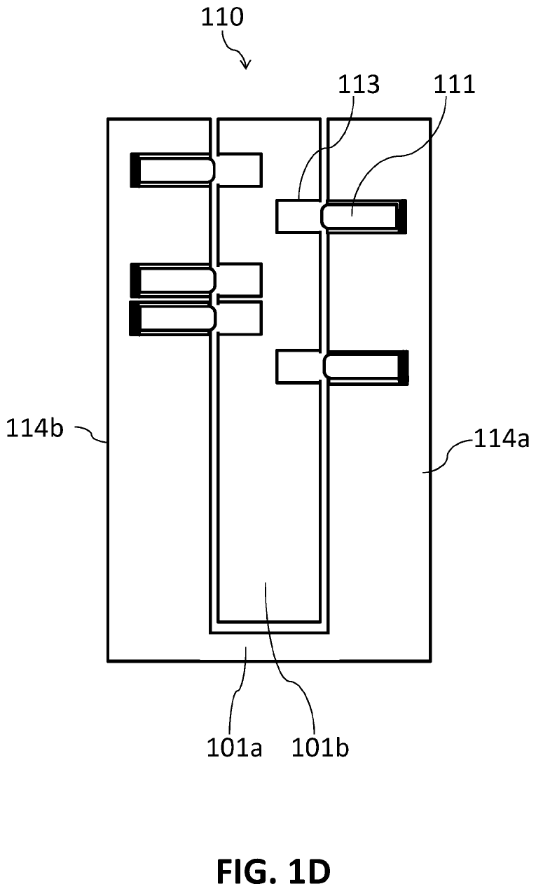

FIG. 1A schematically illustrates a portable device in form of a personal portable power bank 101, according to an embodiment of the present invention. Power bank 101 comprises a housing 101a and a replaceable battery pack 101b. FIG. 1B shows power bank 101 with battery pack 101b partially inserted into housing 101a through an aperture 102. Power bank 101 comprises one or more ports and/or connectors suitable to provide electrical power to and from battery pack 101b. For example, according to one embodiment of the invention, power bank 101 comprises a discharge cable 105 suitable to provide charge from power bank 101 to an electrical device connected to cable 105. According to some embodiments of the invention, power bank 101 may further comprise a recharge port (not shown) through which battery pack 101b of power bank 101 is recharged. For example, the recharge port can be in the form of a micro-USB port suitable to receive a micro-USB connector, or the recharge port can be configured to receive a power cable connector through which battery pack 101b may be recharged.

When battery pack 101b is inserted into housing 101a it is reversibly locked therein in a way that it can be locked or unlocked by using automation means. For example, the automation means are configured to unlock a combination locking arrangement for enabling to release battery pack 101b out of housing 101a. According to an embodiment of the present invention, battery pack 101b is magnetically locked in housing 101a. FIG. 1C schematically illustrates a side cutaway view of a magnetic locking arrangement 110 suitable to lock battery pack 101b in housing 101a, according to an embodiment of the invention. A combination of magnetic pins (e.g. as indicated by numeral 111) in the front and back sides, 114a and 114b, of housing 101a protrude inwards towards corresponding grooves (e.g. as indicated by numeral 113) in battery pack 101b, thereby locking battery pack 101b within housing 101a and preventing movement of the battery pack. In order to unlock battery pack 101b (e.g., to allow movement of battery pack 101b in order to replace it with another battery pack, preferably with a charged battery pack), pins 111 may be retracted by applying magnetic force to the appropriate sides of the pins. For example, the automation means are configured to apply the magnetic force simultaneously to all pins 111 in order to unlock battery pack 101b, or they may apply the magnetic force in a specific order to each magnetic pin in order to gradually pull out battery pack 101b out of housing 101a.

It is noted that the present invention is not limited to a specific method of locking battery pack 101b in housing 101a. Other locking methods and corresponding unlocking arrangements may be used, such as an active member either on the housing, on the battery pack or on both, and a passive member either on the housing, on the battery pack or on both. Other lock arrangements may include other magnetically actuated components or otherwise mechanical components (e.g. springs, leafs etc.), electrical components or a combination of components that are cooperatively sufficient to keep a battery pack locked inside a housing.

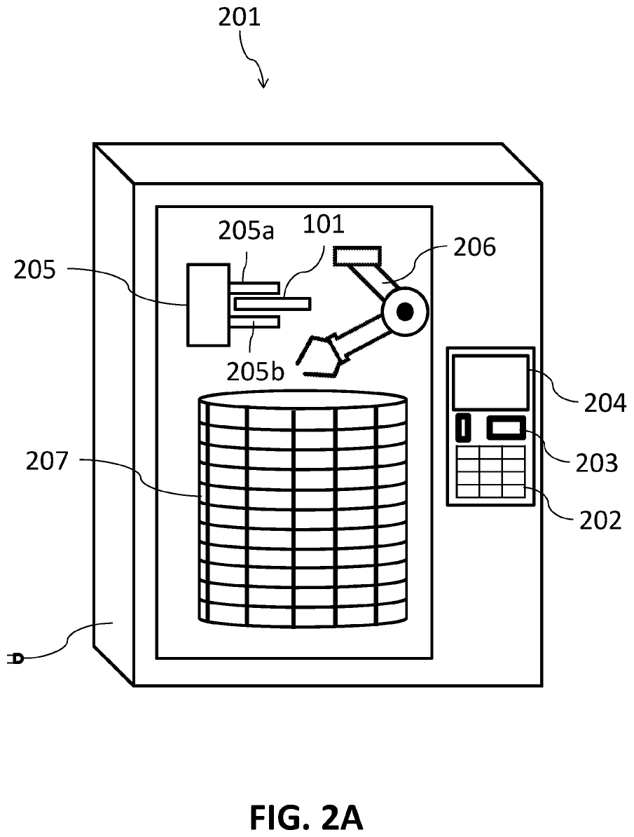

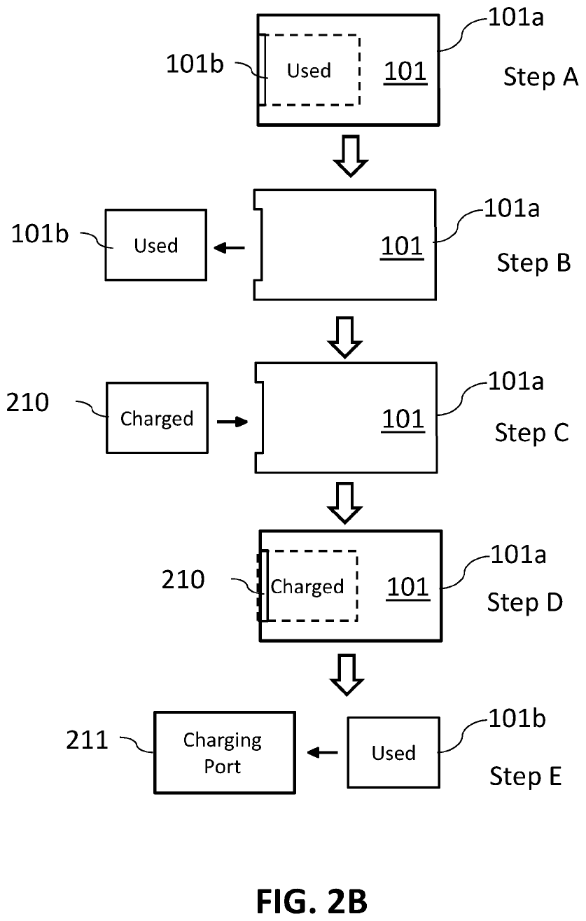

FIG. 2A schematically illustrates a perspective view of an apparatus 201 for replacing used battery of a portable device such as power bank 101, according to an embodiment of the present invention. Apparatus 201 comprises a control panel 202, a portable device insertion aperture 203 (i.e., an insertion port) and a battery storage and management unit 207. Control panel 202 may include a display 204 or control panel 202 can be provided in form of a touch screen to enable human-machine interaction. Battery storage and management unit 207 is configured to manage the charging cycle of each battery pack stored therein. Apparatus 201 further comprises a battery replacing mechanism for replacing used battery of portable devices (e.g., power banks or mobile devices such as smartphones). According to an embodiment of the invention, the battery replacing mechanism comprises an unlocking arrangement 205 for unlocking battery packs from their respective housings (e.g., from battery pack housing 101a or from the body of a mobile device), a grabbing element 206 for extracting used battery packs from their respective housings, and for inserting charged battery packs into housings.

Unlocking arrangement 205 comprises corresponding unlocking means adapted to unlock the used battery pack. For example, unlocking arrangement 205 may comprise magnetic means such as elements 205a and 205b that are adapted to retract magnetic pins 111 of power bank 101 by applying magnetic force to the appropriate sides of power bank 101 (as schematically indicated in the figure). Thus, when the magnetic force is applied, battery pack 101b is unlocked and grabbing element 206 is now able to extract battery pack 101b out of housing 101a.

FIG. 2B schematically illustrates the replacement procedure of a used battery pack 101b with a charged battery pack 210. At step A, unlocking arrangement 205 unlocks battery pack 101b. At step B, when battery pack 101b is unlocked, apparatus 201 extracts battery pack 101b out of the portable device (in this example, out of housing 101b of power bank 101). At step C, after the extraction of battery pack 101b, grabbing element 206 may retrieve a charged battery pack 210 from battery storage and management unit 207 and, in step D, it inserts the retrieved charged battery pack 210 into housing 101a. Upon completing the battery pack replacing procedure, apparatus 201 may return power bank 101 to the user, e.g., by ejecting the portable device via insertion aperture 203. Apparatus 201 may further comprises a battery checking unit (not shown) that is configured to check the health and overall condition of the used battery pack 101b. For example, the battery checking unit can be used to determine whether the health and overall condition of a used battery pack is suitable for additional charging cycle(s). If the used battery pack 101b is in good health and overall condition, apparatus 201 may connect the used battery pack 101b to a charging port 211 that is associated with storage and management unit 207.

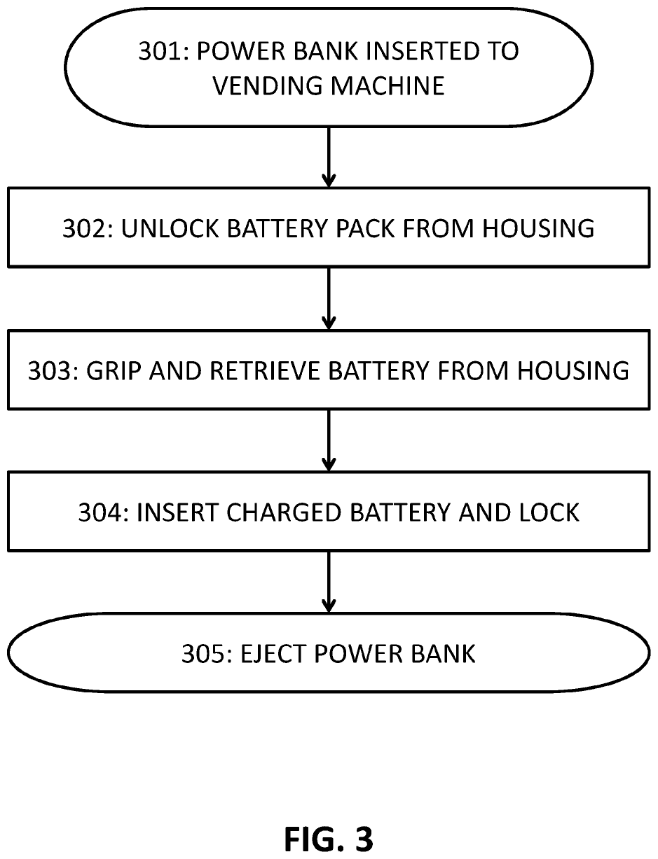

FIG. 3 shows a flowchart describing the process of obtaining a charged battery pack from apparatus 201, according to an embodiment of the present invention. At the first stage 301, a power bank (e.g. 101) is inserted into apparatus 201, after which at stage 302, an unlocking apparatus residing within apparatus 201 unlocks battery pack 101b from the housing 101a. At the next stage 303, a grabbing element grabs unlocked battery pack 101b and removes it from the housing 101a. At the next stage 304, a charged battery pack is inserted into the housing and is locked. At the final stage 305 the power bank 101, now containing a charged battery pack, is ejected from apparatus 201.

In contrast to known prior art systems where either the whole power bank is replaced or the user's personal power bank or mobile device is lengthy charged, a system according to the present invention provides users an experience of speeded portable-device-charging due to each user's personal portable device being returned after the process of obtaining charge, i.e. replacing the battery pack with a charged one.

According to an embodiment of the present invention, after stage 303, i.e. after retrieving a battery pack from its housing, the battery pack's propriety is inspected so as to detect faults and defects, whether they're physical (e.g. dents) or functional faults. A battery pack that was found faulty is returned to the user (i.e. ejected from apparatus 201) and the user is notified that the battery pack is faulty. The user may decide whether to keep the faulty battery or to insert it to apparatus 201 for recycling. According to an embodiment of the invention a faulty battery pack is automatically recycled and a replacement unfaulty battery pack is provided to the user.

It is noted that the process described in FIG. 3 is not limited to replacing battery packs of power banks, and may be applied on other battery-operated mobile devices, e.g. smartphones, digital cameras, navigation devices, wearable computers, etc. Accordingly, a mobile device may be provided with a releasable battery pack, and may be configured to be inserted into a dedicated apparatus configured to replace the used battery pack with a charged battery pack.

According to an embodiment of the invention, an extracted battery pack is inspected for detecting the amount of charge remaining therein. An extracted battery pack is further connected to a charging port for recharging.

According to an embodiment of the present invention, battery pack 101b comprises an identification mark such as RFID, barcode, etc. (not shown in the Figs.) from which the battery pack can be identified. In some embodiments, the portable device may comprise user identification means (e.g., RFID, barcode, etc.). In this embodiment, apparatus 201 is configured to read this identification mark and recognize each battery pack so as to allow tracking and information collecting regarding the usage and charge history of the battery pack and to estimate its remaining life expectancy. In addition, apparatus 201 may identify the user by reading the user identification means. According to an embodiment of the invention, apparatus 201 further comprises a communication module suitable to communicate with a remote database on which history of each battery pack is recorded and stored, as well as user data. For example, by identifying the user, during the battery pack replacement procedure, display 204 of apparatus 201 may show content according to the stored user data.

According to another embodiment of the invention, battery pack 101b further comprises a processing unit (not shown in the Figs.) configured to detect charge activity of the battery pack that doesn't take place within apparatus 201 to further enhance tracking and information collecting. In this embodiment apparatus 201 is configured to read data from the processing unit.

According to an embodiment of the present invention, housing 101a is provided with a unique identification mark (e.g. RFID) associating the housing with a user. The mark may be used for various services such as paying for battery exchanging, statistical usage data, etc. In this embodiment apparatus 201 is configured to recognize each housing by reading identification marks.

According to an embodiment of the invention, apparatus 201 comprises a processing unit (not shown in the Figs.). The processing unit may be used for managing the recharging of battery packs located inside apparatus 201. For instance, the processing unit may be configured to allow battery packs to be optimally recharged, for example, recharged only at times of reduced electricity rate, or it may be configured to prevent over-charging of battery packs. The processing unit may further be used for failure analysis of battery packs, i.e. for identifying usable and defected battery packs. The processing unit may further be used for managing the battery pack inventory, sorting battery packs according to their condition (i.e., defected or usable). According to another embodiment of the invention, defected batteries are stored in a battery pack recycling receptacle inside apparatus 201 so as to prevent defected battery packs from being supplied to a user and for safe disposing thereof.

According to an embodiment of the present invention, a software application for electrical devices may be installed on a user's electrical device and may be used for identifying the user, tracking and managing usage of the power bank and storing user data in a remote database. For instance, the software application may be installed on a user's smartphone and used for directing a user to a nearest apparatus for replacing the used battery pack in case the portable device is low on charge. According to another embodiment of the present invention, during a charging process of the portable device (e.g., by using common charging means), the software application can be used to display content (e.g., commercial content) according to the stored user data.

Although embodiments of the invention have been described by way of illustration, it will be understood that the invention may be carried out with many variations, modifications, and adaptations, without exceeding the scope of the claims.

1. An apparatus for automatically replacing a used battery pack of a portable device with a charged battery pack, comprising:
(a) a plurality of battery packs, either charged or suitable to be recharged, wherein each battery pack comprises a housing suitable to house the battery pack, and a locking arrangement adapted to reversibly lock the battery pack within the housing;
(b) an aperture configured to receive the portable device through which said portable device is inserted in order to replace its battery pack with the charged battery pack and upon completion of replacement, said portable device is ejected through said aperture;
(c) an unlocking apparatus for automatically unlocking the battery pack from the housing of the inserted portable device;
(d) a grabbing element for retrieving the unlocked battery pack from said portable device; and
(e) an insertion element for inserting charged battery pack into the housing of the portable device, thereby enabling replacing the used battery pack of said portable device with the charged battery pack without replacing the housing.

2. The apparatus according to claim 1, wherein the battery pack comprises a locking arrangement with which the battery pack is reversibly locked inside the housing.

3. The apparatus according to claim 1, wherein the housing comprises a locking arrangement with which the battery pack is reversibly locked inside the housing.

4. The apparatus according to claim 1, wherein the battery pack and the housing comprise corresponding locking arrangements with which the battery pack is reversibly locked inside the housing.

5. The apparatus according to claim 1, wherein a housed battery pack is reversibly magnetically locked inside the housing.

6. The apparatus according to claim 1, wherein the battery pack comprises a processing unit configured to detect charge activity of the battery pack.

7. The apparatus according to claim 1, further comprising a processing unit.

8. The apparatus according to claim 1, further comprising a communication module.

9. The apparatus according to claim 1, further comprising a battery pack recycling receptacle.

10. The apparatus according to claim 1, further comprising a battery checking unit configured to check the health and overall condition of the used battery pack, thereby enabling to determine whether the health and overall condition of the battery is suitable for additional charging cycle.

11. The apparatus according to claim 7, wherein the processing unit is used for managing the recharging of the battery packs and to allow one or more of said battery packs to be optimally recharged.

12. A system for replacing used battery packs of portable devices, comprising:
(a) a plurality of portable devices according to claim 1; and
(b) one or more apparatuses according to claim 1.

13. The system according to claim 12, wherein the battery packs of the plurality of portable devices comprise an identification mark.

14. The system according to claim 12, wherein the housings of the plurality of portable devices comprise identification means.

15. The system according to claim 12, further comprising a software application for mobile electrical devices configured to track and manage usage of battery packs.

16. A method of providing charge to a portable device according to claim 1, comprising:
(a) unlocking the battery pack;
(b) gripping and retrieving the battery pack from the housing; and
(c) inserting a charged battery pack into the housing.

17. The method according to claim 16 performed by an apparatus according to claim 1, wherein the portable device is inserted to the apparatus before the used battery pack is unlocked and is ejected from the apparatus after the charged battery pack is inserted into the housing.

18-23. (canceled)

24. An apparatus for battery operated rechargeable mobile devices configured to receive a battery operated rechargeable mobile device and replace the battery pack of the mobile device with a charged battery pack.

25. A method of providing charge to a battery operated rechargeable mobile device with a removable battery pack by using automation means, comprising:
(a) inserting the mobile device into a dedicated apparatus that is adapted for replacing a used battery pack of the mobile device;
(b) unlocking the used battery pack;
(c) gripping and extracting the used battery pack from the housing;
(d) inserting a charged battery pack into the housing; and
(e) ejecting the mobile device from the apparatus.
